(19) United States
(12) Patent Application Publication
(10) Pub. No.: US 2026/0186651 A1
(43) Pub. Date: Jul. 2, 2026

(54) EXPANDED LOG STORAGE CAPACITY IN A MEMORY SUB-SYSTEM

(71) Applicant: Micron Technology, Inc., Boise, ID (US)

(72) Inventor: Jian Wu, Shanghai (CN)

(21) Appl. No.: 19/007,253

(22) Filed: Dec. 31, 2024

(51) Int. Cl. G06F 3/06

(52) U.S. Cl. CPC G06F 3/0608; G06F 3/0631; G06F 3/0656; G06F 3/0673

(57) ABSTRACT

A processing device in a memory system generates one or more debug logs storing debug data and stores the one or more debug logs in a buffer. Responsive to determining that a buffer occupancy of the buffer satisfies a threshold criterion, the processing device applies a compression algorithm to the one or more debug logs to generate one or more compressed debug logs. The processing device further stores the one or more compressed debug logs in an allocated storage space in the memory device,

### TECHNICAL FIELD

Embodiments of the disclosure relate generally to memory sub-systems, and more specifically, relate to expanded log storage capacity in memory sub-systems.

### BACKGROUND

A memory sub-system can include one or more memory devices that store data. The memory devices can be, for example, non-volatile memory devices and volatile memory devices. In general, a memory sub-system can store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a flow diagram of an example method to enlarge log storage capacity in memory sub-systems in accordance with some embodiments of the present disclosure.

FIG. 3 is a block diagram depicting an example method to enlarge log storage capacity in a memory sub-system in accordance with the present disclosure.

FIG. 4 is a block diagram of an example computer system in which embodiments of the present disclosure may operate.

### DETAILED DESCRIPTION

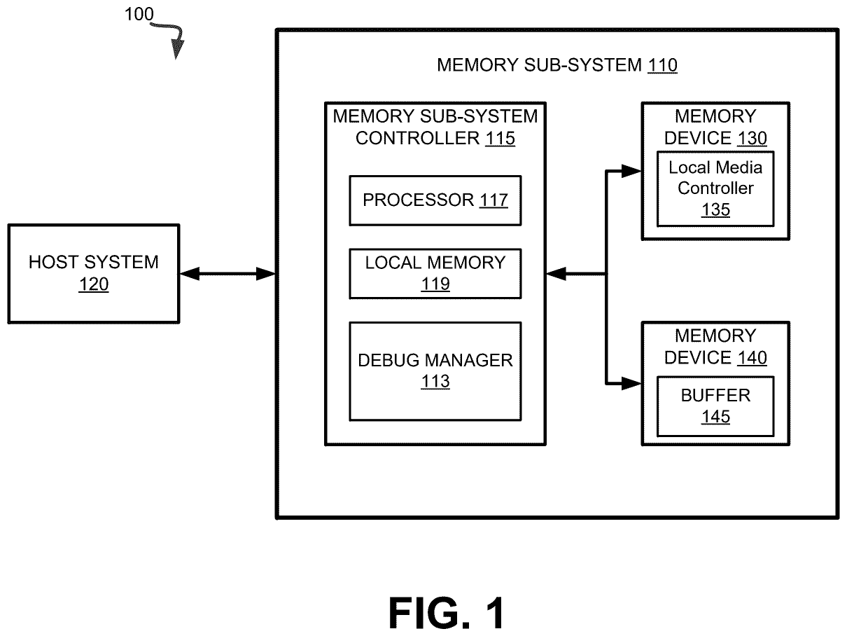

Aspects of the present disclosure are directed to expanded log storage capacity in memory sub-systems. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Like any electronic circuit, a memory sub-system is susceptible to various types of errors or faults that can impact performance and/or operability. For example, faults in the firmware executing on the memory sub-system can cause the memory sub-system to become unresponsive, input/output errors can prevent communication with the host system, or a failure in the non-volatile memory devices of the memory sub-system can hinder the storage or retention of data. Debugging is a methodical process of identifying and reducing the number of defects (i.e., “bugs”) in a memory sub-system that cause the aforementioned error or faults. Various debug techniques can be used to detect anomalies, assess their impact, and schedule hardware changes, firmware upgrades, or full updates to the memory sub-system. The goals of debugging include identifying and fixing bugs in the system (e.g., logical or synchronization problems in the firmware, or a design error in the hardware) and collecting system state information, such as information about the operation of the memory sub-system, that may then be used to analyze the memory sub-system to find ways to recover from faults, boost its performance, or to optimize other important characteristics in a process known as debugging analysis.

In certain systems, debugging operations or other analyses of the memory sub-system are performed in the memory sub-system. Upon the completion of a debugging operation, a debug log is generated to store the debugging information, such as system state information, statistics, runtime analytics, etc. The debug logs are stored in a buffer and then written to non-volatile flash memory (e.g., NAND memory) in the memory sub-system, where they can be accessed for debugging analysis. However, the allocated storage space for debug logs on the NAND memory is fixed. As such, if the amount of debug logs that are generated exceeds the capacity of the allocated storage space in the NAND, the older debug logs on the NAND may be overwritten. Incomplete debug logs can lack crucial information about the state of the system or debugging strategies that were used to effectively identify and resolve bugs, making it difficult to conduct an effective debugging analysis and thus reducing the efficiency in resolving system issues.

Previous solutions include allocating space in proportion to the importance of the debug log type. Common log types include telemetry logs, workload logs, and event logs.

Telemetry logs store data on system errors, uncaught exceptions, system crashes, etc. Workload logs record drive status, such as task performance, resource utilization, errors during task execution, and dependencies during task execution. Event logs record detailed, timestamped information on drive activity, which may be considered the most important for debugging purposes. As such, in certain systems, all logs are allocated the required minimum storage space except for event logs, which are allocated the remaining space. Because the event logs are allocated the most storage, they are less likely to be incomplete or overwritten.

However, the allocation of space based on log type does not fully resolve the issue because debug logs can still be overwritten due to lack of space. While the solution may offer more complete event logs for debugging analysis, the solution does not directly address the issue of the allocated storage space on the NAND being potentially insufficient. Additionally, for telemetry and workload logs, this solution can even exacerbate the problem, as there is less space allocated for these types of logs, increasing the likelihood of them being overwritten. As such, the solution does not completely address the issue of debug logs being overwritten due to a lack of storage space.

Additional solutions include optimizing the debug log structure (e.g. using garbage collection to remove invalid data and increase the proportion of valid data) to use the allocated space more effectively. However, debug log information is often stored with timestamps and other decoder information that require additional space, making it difficult to exceed a ratio of 1 to 1 effective storage efficiency, where the amount of stored data is equal to the amount of storage capacity used to store the data, even with optimization. As such, the solution does not completely address the overwriting of debug logs due to lack of space.

Aspects of the present disclosure address the above-noted and other deficiencies by compressing the debug logs before writing them to the NAND in order to effectively expand the log storage capacity. In one embodiment, processing logic in the memory sub-system controller can store the debug logs in a buffer, which, for example, can be implemented using volatile memory in the memory sub-system. In one embodiment, the buffer can be larger than the write size granularity (e.g., page write size) of the NAND (e.g., an integer multiple of the page write size). Once the buffer is full, the processing logic can apply a compression algorithm to the debug logs to generate compressed debug data and then write the compressed debug data to the allocated storage space in the NAND.

Advantages of the approach described herein include but are not limited to increasing storage capacity and debugging efficiency. By compressing the debug log data before writing it to NAND, the effective storage efficiency can exceed a ratio of 1 unit of data stored to 1 unit of storage used, allowing for more data to be stored without changing the size of the allocated storage space. The increased storage capacity also decreases the likelihood of debug logs being overwritten due to lack of space. With complete debug logs, debugging analysis can be more effective and efficient because debug data necessary to identify and resolve system issues will not be lost. Additionally, the ability to store more data without expanding the allocated storage space allows for the remaining space in the NAND to be allocated for other types of host data, increasing efficiency of the system as a whole.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IOT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

In one embodiment, the memory sub-system 110 includes a debug manager component 113 that coordinates the transfer of debug logs to an allocated storage space in memory device 130. In some embodiments, the memory sub-system controller 115 includes at least a portion of the debug manager component 113. In some embodiments, the debug manager component 113 is part of the host system 120, an application, or an operating system. In other embodiments, local media controller 135 includes at least a portion of debug manager component 113 and is configured to perform the functionality described herein.

In some embodiments, the debug manager component 113 generates one or more debug logs for the memory sub-system 110 and stores them in a buffer 145, which may be located on volatile memory device 140, for example. Once the buffer 145 has been filled to a threshold amount, the debug manager component 113 can apply a compression algorithm to the one or more debug logs stored in the buffer 145. The debug manager component 113 can then store the one or more compressed debug logs in the allocated storage space in non-volatile memory device 130. The debug logs can include, for example, system state information, statistics, runtime analytics, etc. Further details with regards to the operations of the debug manager component 113 are described below.

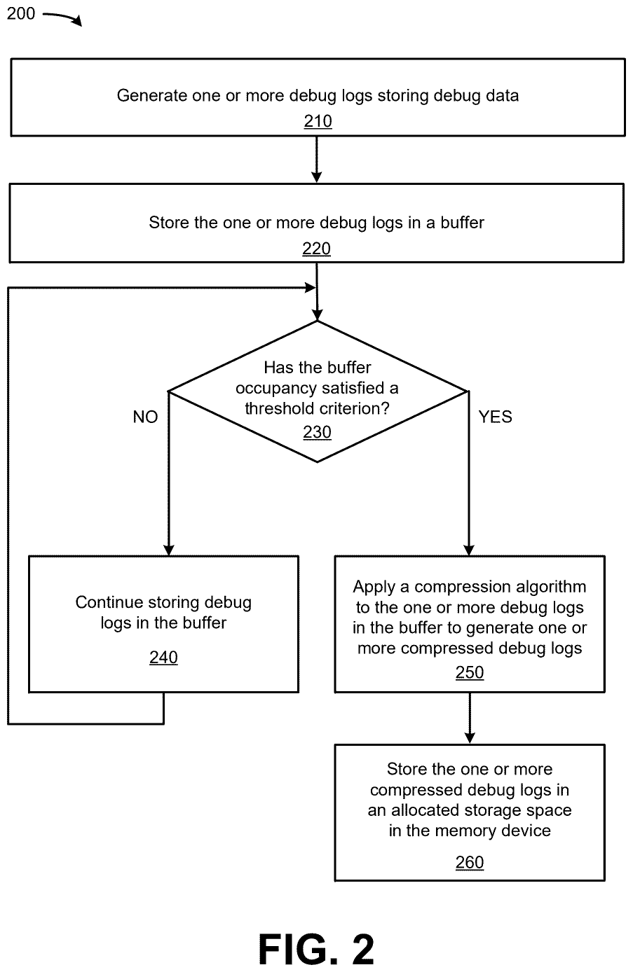

FIG. 2 is a flow diagram of an example method 200 memory sub-system operation to compress debug logs and write them to nonvolatile memory, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the debug manager component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, the processing logic (e.g., debug manager component 113), generates one or more debug logs storing debug data for the memory sub-system 110. Debug data can include information on drive activity, drive status, system errors, etc. In some embodiments, the one or more debug logs includes one or more of telemetry logs, workload logs, or event logs. The debug manager component 113 can generate the debug logs by monitoring, recording, and storing system data during and/or after an error event (e.g., read/write failure, error correction code errors, etc.), an unexpected power loss, or a firmware update. In some embodiments, debug logs may be generated continuously for health and performance monitoring (e.g., self-monitoring, analysis, and reporting technology (SMART) logs)).

At operation 220, the processing logic stores the one or more debug logs in a buffer 145 (e.g., a write buffer). In some embodiments, the buffer 145 can be located on a volatile memory device (e.g., memory device 140). The volatile memory device can be a DRAM. In other embodiments, the buffer 145 can be located on SRAM (e.g., local memory 119).

Depending on the embodiment, the processing logic 220 can send the one or more debug logs to the volatile memory device through a memory bus that adheres to the double data rate (DDR) protocol. In some embodiments, the one or more debug logs can be stored in the format of a structure, a string, or a fixed format.

At operation 230, the processing logic determines whether a buffer occupancy of the buffer 145 has satisfied a threshold criterion. In some embodiments, the debug manager component 113 can determine if the buffer 145 has been filled to a specified threshold. For example, the debug manager component 113 can determine that the threshold criterion is satisfied when the buffer 145 has been filled to 75% of its capacity. In other embodiments, the threshold can be a specified amount (e.g., 64 kilobytes (KB)) rather than a proportion of the buffer size. Responsive to determining that the buffer 145 has not satisfied the threshold criterion, at operation 240, the processing logic continues storing debug logs in the buffer 145. After more debug logs are stored in the buffer 145, the processing logic proceeds to operation 230 to determine if the buffer 145 has been filled to the threshold.

Responsive to determining that the buffer 145 has satisfied the threshold criterion, at operation 250, the processing logic applies a compression algorithm to the one or more debug logs stored in the buffer 145 to generate one or more compressed debug logs. In some embodiments, a lossless compression algorithm is used to ensure that debug data is not lost or removed during the compression. For example, the debug manager component 113 can read the one or more debug logs from the buffer 145 located in the volatile memory device (e.g., memory device 140) and apply the Lempel-Ziv-Welch (LZW) algorithm to the one or more debug logs. In some embodiments, the size of the compressed debug logs can correspond to the write size granularity of the non-volatile memory device (e.g., memory device 130) to improve write efficiency when writing the debug logs to the non-volatile memory device. For example, if the write size granularity of the non-volatile memory device 130 is 16 kilobytes (KB), the size of the compressed debug logs can be 16 KB.

At operation 260, the processing logic stores the one or more compressed debug logs in an allocated storage space in a non-volatile memory device (e.g., memory device 130). The allocated storage space can have a fixed size (e.g., 300 megabytes (MB)) that cannot be altered to store additional debug logs. In some embodiments, processing logic may delete the one or more debug logs stored in the buffer 145 after the associated compressed debug logs are stored in the non-volatile memory device (e.g., memory device 130). Deleting the one or more debug logs stored in the buffer 145 creates more storage space for newly generated debug logs and prevents debug logs from being written to the non-volatile memory device (e.g., memory device 130) multiple times.

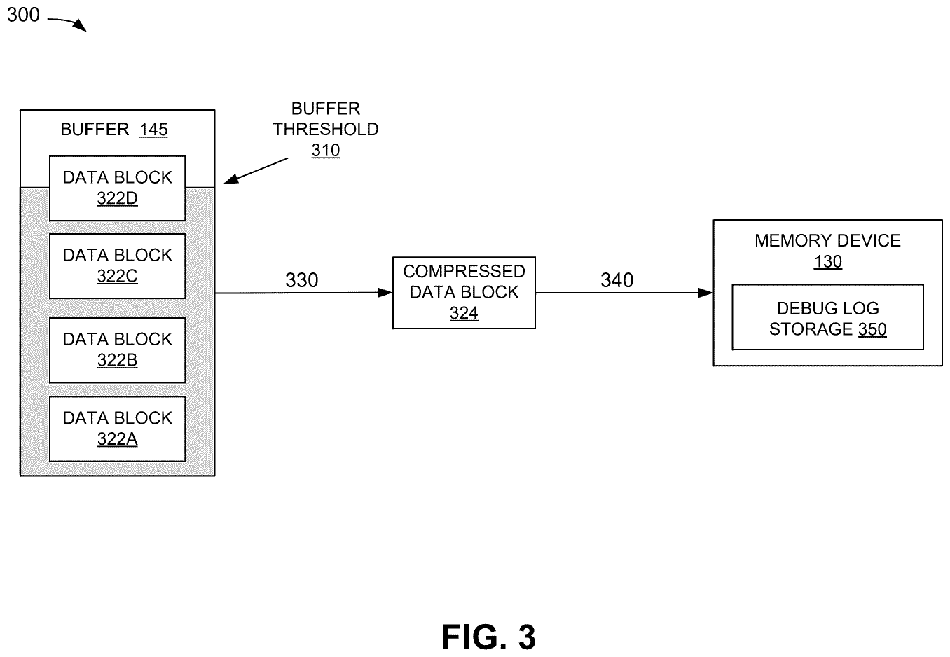

FIG. 3 is a block diagram illustrating the process of compressing and storing the debug logs in a non-volatile memory device (e.g., memory device 130), according to one embodiment. Once a debug log is generated, it can be stored in a data block (e.g., data block 322A-D) in a buffer 145 A debug log can include, for example, an event log, a telemetry log, or a workload log. Depending on the embodiment, a debug log can be stored in the form of a structure, string, or fixed format. A structure is an organized collection of data grouped together in a way that represents the relationships between data. A string is a sequence of characters representing textual data. A fixed format is a predefined layout where each type of data is stored in a specific position and, in some embodiments, with length requirements.

As described above, the buffer 145 may be located on DRAM (e.g., memory device 140) in some embodiments. In other embodiments, the buffer 145 may be located on SRAM (e.g., local memory 119). Depending on the embodiment, the buffer 145 can be a write buffer, a cache buffer, a circular buffer, or a log buffer. In some embodiments, the buffer 145 can have a buffer threshold 310. The buffer threshold 310 may be a proportion of the size of the buffer 145 (e.g., 75% of the buffer size). In other embodiments, the buffer threshold may be a fixed amount (e.g., 64 kilobytes (KB)).

When the buffer 145 is filled with enough data blocks 322A-D to meet or exceed the buffer threshold 310, processing logic (e.g., the debug manager component 113) will perform a compression operation at 330 to compress the one or more debug logs stored in the data blocks 322A-D. Depending on the embodiment, the compression algorithm can be a lossless compression algorithm (e.g., LZW algorithm) that reduces the size of the debug logs in the data blocks 322A-D without discarding any debug data. Lossless compression ensures that the debug logs can be restored to the original form and retain all the information necessary for debug analysis after being compressed and stored. The compressed data block 324 represents data blocks 322A-D that have been compressed using a lossless compression algorithm. The compressed data block 324 will be smaller than the total size of data blocks 322A-D.

Depending on the embodiment, the buffer 145 and/or the buffer threshold 310 can be an integer multiple of a write size granularity (e.g., page write size) of memory device 130 to ensure that the debug logs remain properly aligned and match page boundaries when written to memory device 130. For example, if the page write size of memory device 130 is 16 kilobytes (KB), the size of buffer threshold 310 can be 64 KB. When there is 64 KB of debug logs stored in data blocks 322A-D, processing logic compresses the data blocks 322A-D to generate compressed data block 324, which stores the compressed debug logs. The size of compressed data block 324 can be an integer multiple of the page write size, such as 16 KB or 32 KB. Aligning the size of the buffer 145 and/or the buffer threshold 310 with the write granularity of the memory device 130 can prevent partial writes, improving write efficiency and ensuring that the debug logs are written correctly.

The compressed data block 324 is written to the memory device 130 and stored in debug log storage 350, a storage space in memory device 130 that is allocated for debug logs. In some embodiments, the size of the debug log storage 350 is fixed and cannot be expanded. For example, in one embodiment, the debug log storage 350 can store 300 megabytes (MB) of debug logs and cannot be altered to store more than the allocated 300 MB. Once stored, the debug logs can later be accessed and decompressed to the original form for debug analysis. In some embodiments, after the compressed debug logs are stored in memory device 130, the debug logs stored in buffer 145 can be deleted to make room for new debug logs.

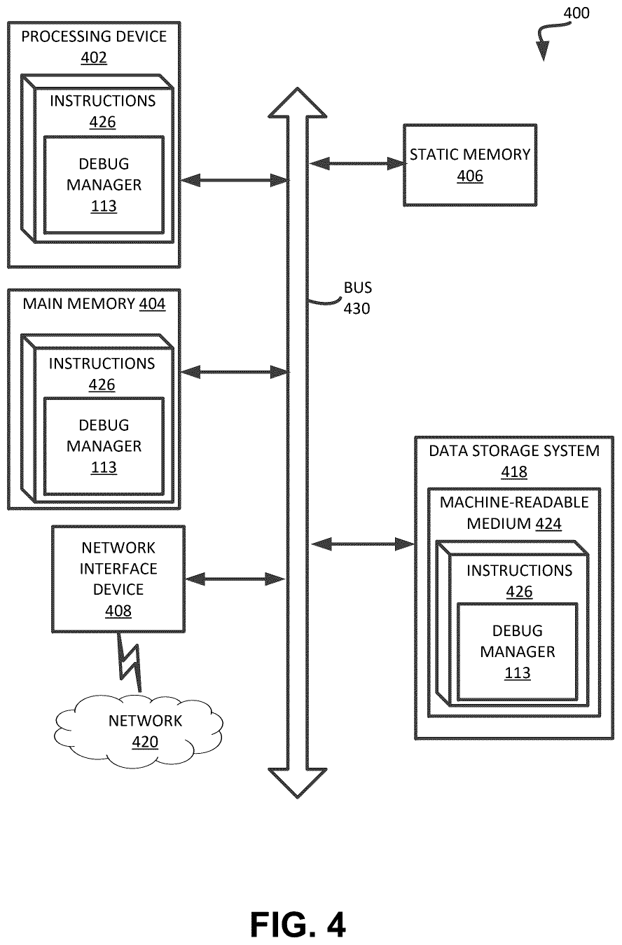

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the debug manager component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to the debug manager component 113 of FIG. 1. While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, to perform operations comprising:
generating one or more debug logs storing debug data for the system;
storing the one or more debug logs in a buffer;
responsive to determining that a buffer occupancy of the buffer satisfies a threshold criterion, applying a compression algorithm on the one or more debug logs in the buffer to generate one or more compressed debug logs, wherein the threshold criterion corresponds to an integer multiple of a page write size of the memory device; and
storing the one or more compressed debug logs in an allocated storage space in the memory device.

2. The system of claim 1, wherein applying the compression algorithm reduces a size of the one or more debug logs from a first size to a second size, wherein the first size is an integer multiple of the second size, and wherein the second size corresponds to a write size granularity of the memory device.

3. The system of claim 1 wherein the compression algorithm comprises a lossless compression algorithm.

4. The system of claim 1, wherein the processing device is to perform operations further comprising:
responsive to storing the one or more compressed debug logs in the allocated storage space in the memory device, deleting the one or more debug logs stored in the buffer.

5. The system of claim 1, wherein the one or more debug logs are stored as one of: a structure, a string, or a fixed format.

6. The system of claim 1, wherein the allocated storage space has a fixed size.

7. The system of claim 1, further comprising:
a volatile memory device, wherein the volatile memory device stores the buffer.

8. A method comprising:
generating one or more debug logs storing debug data for a system;
storing the one or more debug logs in a buffer;
responsive to determining that a buffer occupancy of the buffer satisfies a threshold criterion, applying a compression algorithm on the one or more debug logs in the buffer to generate one or more compressed debug logs, wherein the threshold criterion corresponds to an integer multiple of a page write size of a memory device; and
storing the one or more compressed debug logs in an allocated storage space in the memory device.

9. The method of claim 8, wherein applying the compression algorithm reduces a size of the one or more debug logs from a first size to a second size, wherein the first size is an integer multiple of the second size, and wherein the second size corresponds to a write size granularity of the memory device.

10. The method of claim 8, wherein the compression algorithm comprises a lossless compression algorithm.

11. The method of claim 8, further comprising:
responsive to storing the one or more compressed debug logs in the allocated storage space in the memory device, deleting the one or more debug logs stored in the buffer.

12. The method of claim 8, wherein the one or more debug logs are stored as one of: a structure, a string, or a fixed format.

13. The method of claim 8, wherein the allocated storage space has a fixed size.

14. The method of claim 8, wherein a volatile memory device stores the buffer.

15. A non-transitory computer-readable storage medium comprising instructions that, when executed by a processing device, cause the processing device to perform operations comprising:
generating one or more debug logs storing debug data for a system;
storing the one or more debug logs in a buffer;
responsive to determining that a buffer occupancy of the buffer satisfies a threshold criterion, applying a compression algorithm on the one or more debug logs in the buffer to generate one or more compressed debug logs, wherein the threshold criterion corresponds to an integer multiple of a page write size of a memory device; and
storing the one or more compressed debug logs in an allocated storage space in the memory device.

16. The non-transitory computer-readable storage medium of claim 15, wherein applying the compression algorithm reduces a size of the one or more debug logs from a first size to a second size, wherein the first size is an integer multiple of the second size, and wherein the second size corresponds to a write size granularity of the memory device.

17. The non-transitory computer-readable storage medium of claim 15, wherein the compression algorithm comprises a lossless compression algorithm.

18. The non-transitory computer-readable storage medium of claim 15, further comprising:
responsive to storing the one or more compressed debug logs in the allocated storage space in the memory device, deleting the one or more debug logs stored in the buffer.

19. The non-transitory computer-readable storage medium of claim 15, wherein the one or more debug logs are stored as one of: a structure, a string, or a fixed format.

20. The non-transitory computer-readable storage medium of claim 15, wherein the allocated storage space has a fixed size, and wherein a volatile memory device stores the buffer.
